(19) United States
(12) Patent Application Publication
(10) Pub. No.: US 2021/0316423 A1
(43) Pub. Date: Oct. 14, 2021

(54) CUP HEIGHT ADJUSTMENT TOOL

(71) Applicant: GLOBALFOUNDRIES U.S. INC., Santa Clara, CA (US)

(72) Inventor: Richard S. MCDERMOTT, Ballston Spa, NY (US)

(21) Appl. No.: 16/845,629

(22) Filed: Apr. 10, 2020

(51) Int. Cl. B25B 13/48

(52) U.S. Cl. CPC B25B 13/48

(57) ABSTRACT

The present disclosure relates to a tool and, more particularly, to cup height adjustment tool and method of use. The tool includes: a first wrench comprising a handle, a shank portion and an opening extending through the handle and the shank portion; and a second wrench having a handle and a shank portion, the shank portion of the second wrench extending through the opening of the first wrench such that a tip of the shank portion of the second wrench extends beyond the shank portion of the first wrench.

### FIELD OF THE INVENTION

The present disclosure relates to a tool and, more particularly, to cup height adjustment tool and method of use.

### BACKGROUND

Semiconductor fabrication processes are complex processes requiring specialized tools and equipment. These tools include lithography machines, vapor deposition chambers and wafer spin chucks, to name a few. The wafer spin chuck, for example, is used for many types of semiconductor processes including, e.g., etching processes, cleaning processes, photoresist processes, etc. For example, to form desired patterns on a semiconductor substrate an etching process will be used to remove different layers from a wafer, while the wafer is spun.

The wafer spin chuck includes a cup mounted to a frame, with three (3) adjustment screws, each with an inset set screw. A wafer chuck is also mounted to the frame, which is designed to hold the wafer. The cup has an adjustable height, which is adjusted by the turning of the adjustment screw. Once the height of the cup is at its desired level, the tool to rotate the adjustment screw is removed and another tool is used to rotate the set screw thereby locking the cup in place. However, during the locking process, the adjustment screw may also turn which can affect the height of the cup. Accordingly, it becomes a tedious and time consuming process to adjust the height of the cup and lock it in place.

### SUMMARY

In an aspect of the disclosure, a tool comprises: a first wrench comprising a handle, a shank portion and an opening extending through the handle and the shank portion; and a second wrench having a handle and a shank portion, the shank portion of the second wrench extending through the opening of the first wrench such that a tip of the shank portion of the second wrench extends beyond the shank portion of the first wrench.

In an aspect of the disclosure, a tool comprises: a “L” shaped tool comprising a hollow shank with an exterior cross-sectional configuration structured to engage with a drive portion of a first fastener; and a “T” shaped tool comprising a shank insertable through the hollow shank and having an exterior cross-sectional configuration structured to engage with a drive portion of a second fastener.

In an aspect of the disclosure, a tool comprises: a first wrench comprising a handle with an opening and a hollow shank, the opening being aligned with the hollow shank; and a second wrench comprising a shank insertable through the opening and the hollow shank, such that the hollow shank and the shank are axially alignable and independently rotatable.

### BRIEF DESCRIPTION OF THE DRAWINGS

The present disclosure is described in the detailed description which follows, in reference to the noted plurality of drawings by way of non-limiting examples of exemplary embodiments of the present disclosure.

FIG. 1 shows a perspective view of a tool in accordance with aspects of the present disclosure.

FIGS. 2A and 2B show a side view and bottom-up view, respectively, of a wrench of the tool in accordance with aspects of the present disclosure.

FIG. 2C shows several cross-sectional views of a tip of the wrench shown in FIGS. 1, 2A and 2B, in accordance with aspects of the present disclosure.

FIGS. 3A and 3B show a side cutaway view and bottom-up view, respectively, of another wrench of the tool in accordance with aspects of the present disclosure.

FIG. 4 shows an illustrative example of a wafer spin chuck and accompanying features.

FIG. 5 shows the tool of FIG. 1 in operational use with the illustrative example of the wafer spin chuck of FIG. 4.

### DETAILED DESCRIPTION

The present disclosure relates to a tool and, more particularly, to cup height adjustment tool and method of use. More specifically, the present disclosure relates to a cup height adjustment wrench structured to hold and maintain an adjustment screw of a cup of a wafer spin chuck in position, during a cup set or locking process. Advantageously, the cup height adjustment wrench allows a technician to adjust the locking screw (also known as a set screw) of the cup for the wafer spin chuck with no movement of the adjustment screw, thereby ensuring the height of the cup is maintained during the locking process.

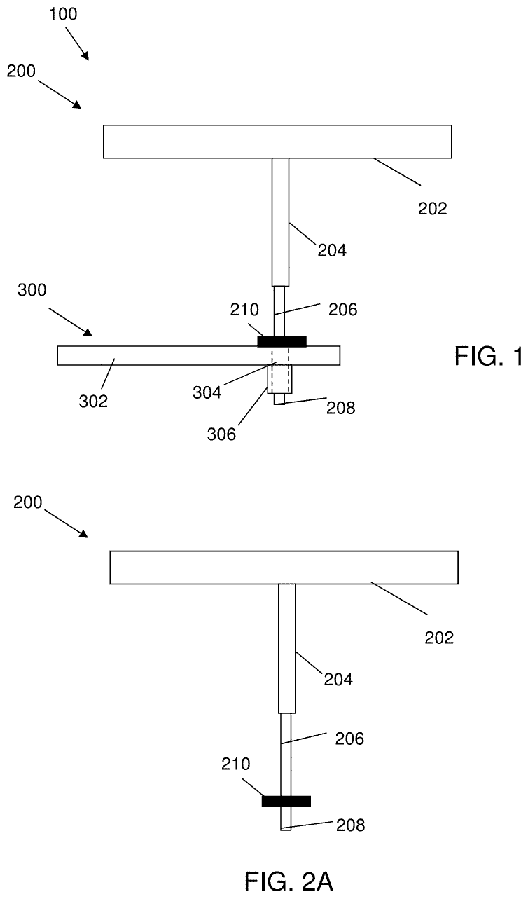

FIG. 1 shows a perspective view of the tool in accordance with aspects of the present disclosure. In embodiments, the tool 100 includes two wrenches 200, 300 which are mated together through an opening 304 of the wrench 300. More specifically, the wrench 200 includes a handle 202 which is attached to a downwardly extending shank 204. In embodiments, the combination of the handle 202 and the downwardly extending shank 204 forms a T-shaped tool; although other shapes are also contemplated herein. For example, the combination of the handle 202 and downwardly extending shank potion 204 can form an L-shaped tool. The handle 202 can be ergonomically designed to fit into the hand of an operator or technician, facilitating the turning or rotation of the wrench 200, itself, to lock a set screw of the cup of the wafer spin chuck. The downwardly extending shank 204 includes a cross-sectional configuration 206 which extends, at least, to its lower portion, e.g., tip 208.

An optional stop mechanism 210 can be provided on the shank 204, at a certain height. The optional stop mechanism 210 can rest on the top of the handle 302, providing additional force on the wrench 300, maintaining the wrench in its desired location (e.g., keeping the adjustment screw stationary) during the rotation of the wrench 200 during the locking process.

Still referring to FIG. 1, the tip 208 extends through the opening 304 of the wrench 300. In embodiments, the opening 304 of the wrench 300 has a larger cross-section than the cross-sectional configuration 206 of the wrench 200. In this way, the downwardly extending shank 204 can extend completely through the wrench 300 without any interference, allowing the tip 208 of the wrench 200 to engage a head or drive portion of a set screw of the cup of the wafer spin chuck and which can be independently rotated with respect to the rotation of the wrench 300. The shank portion of both wrenches 200, 300 are in axial alignment along their longitudinal axes.

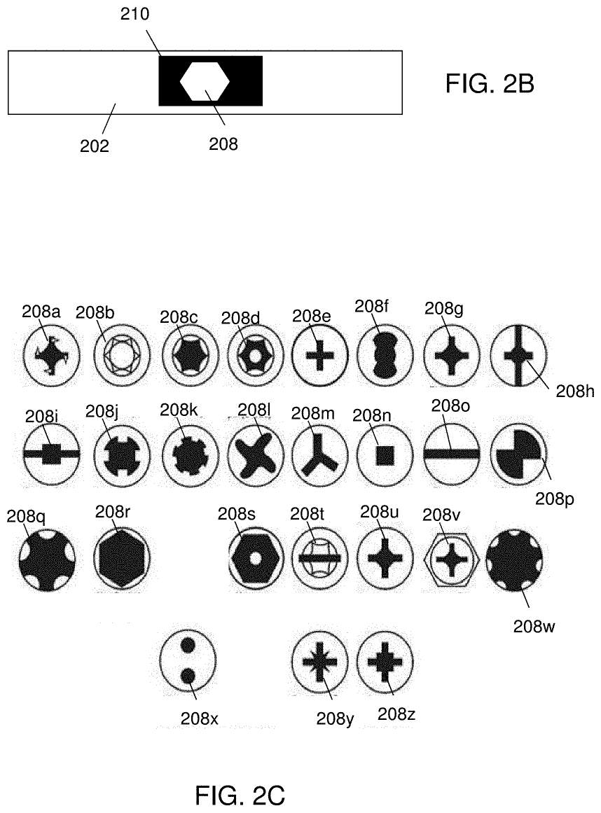

In further embodiments, the cross-sectional configuration 206 can be a hexagonal cross-sectional configuration or other shapes, depending on the configuration of the drive portion of the set screw. For example, the cross-sectional configuration 206 can be, e.g., a Philips head configuration, “X” shaped, slotted, pozidriv, star shaped, etc., as further described with respect to FIG. 2C, each of which would depend on the shape of the drive portion of the set screw. Similarly, the opening 304 of the wrench 300 can be different shapes, including circular, square, hexagonal, etc.

FIGS. 2A and 2B show a side view and bottom-up view, respectively, of the wrench 200. As shown in these views, the wrench 200 is separated or detached from the wrench 300. As previously described, the wrench 200 includes a handle 202 attached to the downwardly extending shank 204. The downwardly extending shank 204 can include an optional stop mechanism 210, which is an outwardly extending tab portion.

The downwardly extending shank 204 includes a cross-sectional configuration 206 extending to the tip 208. As shown in FIG. 2B, the tip 208, for example, has a hexagonal cross-sectional configuration; although other shapes are contemplated herein as shown in FIG. 2C. For example, the cross-sectional configuration of the tip 208 can comprise, amongst other examples: Phillips II 208a; Torx external 6 lobe 208b; Torx internal 6 lobe 208c; Torx internal tamperproof 208d; Frearason 208e; Clutch 208f; Phillips 208g; Phillips slot combination 208h; square slot combination 208i; 4 fluted socket 208j; 6 fluted socket 208k, MorTorq 208l; tri-wing 208m; square 208n, slotted 208o; slotted tamper proof 208p; 5 node security 208q; hex socket and Allen head internal 208r; hexagon internal tamper proof 208s; slotted 6 lobe combo 208t; quadrex 208u; Phillips hex head 208v; 7 node security 208w, spanner drilled tamper proof 208x; pozi drive Phillips 208y; and Phillips square supa drive 208z.

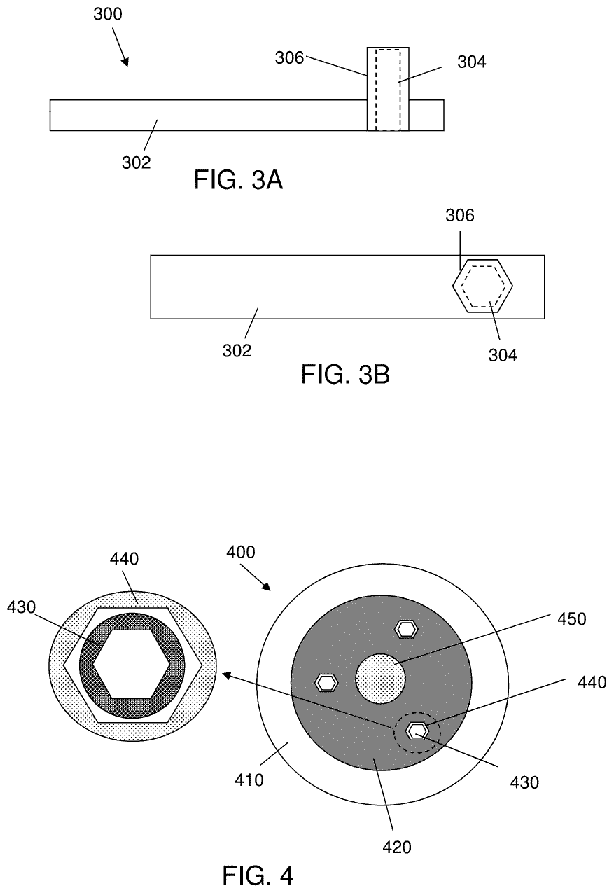

FIGS. 3A and 3B show a side cutaway view and bottom-up view, respectively, of the wrench 300. As shown in FIG. 3A, the wrench 300 includes a handle 302 with a shank portion 306. The shank portion 306 can be fixedly attached to the handle 302 or can be attached to the handle 302 by a ratchet type mechanism. The handle 302 can be ergonomically designed to fit into the hand of an operator or technician, facilitating the turning or rotation of the wrench 300, itself, to adjust the height of the cup of the wafer spin chuck.

As shown in FIG. 3B, the shank portion 306 includes an opening 304 extending along is longitudinal axis, e.g., is hollow. Also, the exterior of the shank portion 306 will have a shape (cross-sectional configuration) that coincides with that of an adjustment screw of the cup of the wafer spin chuck. In embodiments, the shape of the exterior of the shank portion 306 can be hexagonal; although other shapes matching an interior cross-sectional shape of the drive portion of the adjustment screw are contemplated herein (similar to many designs discussed with respect to FIG. 2C).

As further shown in FIGS. 3A and 3B, the opening 304 extends entirely through the shank portion 306 and the handle 302 of the wrench 300. The shape and size of the opening 304 allows the shank 204 and, more particularly, the tip 208 of the wrench 200 to pass entirely through the wrench 300. The shape of the opening 304 can be different shapes, including circular, square, hexagonal, etc., and has a larger cross sectional diameter than the lower portion of the shank 204, e.g., the tip 208. This allows the tip 208 to pass through the wrench 300 and engage the set screw while both wrenches 200, 300 are mated together and in operational use. Also, this configuration allows both the wrenches 200, 300 to be independently rotated without interference from either wrench 200, 300.

FIG. 4 shows an illustrative example of the wafer spin chuck 400 and accompanying features. It should be understood by those of ordinary skill in the art that the wafer spin chuck 400 and accompanying features are not to be considered limiting features of the present disclosure, but are merely provided to describe an environment in which to use the tool 100. As shown in FIG. 4, the wafer spin chuck 400 includes a cup 410 mounted to a frame 420, with set screws 430 and adjustment screws 440. In embodiments, there are three equally spaced apart sets of set screws 430 and adjustment screws 440. A wafer chuck 450 is also mounted to the frame 420.

As shown in FIG. 4, in each of the sets, the set screw 430 is inset and axially aligned with the adjustment screw 440. The set screw 430 and the adjustment screw 440 are both shown with a hexagonal cross section; although as already noted herein, different cross sections can be provided. In use, the adjustment screw 440 is rotated to raise or lower the height of the cup 310 with respect to the frame 420; whereas, the set screw 430 is rotated to lock (or unlock) the cup 410 to its adjusted height.

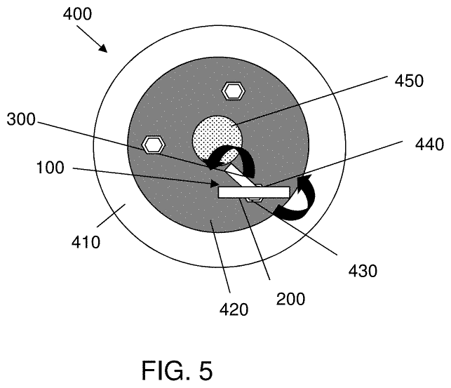

FIG. 5 shows the tool 100 of FIG. 1 in operational use with the illustrative example of the wafer spin chuck of FIG. 4. As representatively shown, the wrenches 200, 300 are mated together allowing them to both independently rotated and engage with the set screw 430 and adjustment screw 440, respectively. First, the wrench 300 is rotated to adjust the height of the cup 310. Thereafter, the wrench 200 is rotated to lock the set screw 430 in place, while the wrench 300 is maintained in its current position. That is, during rotation of the wrench 200 to lock the set screw 430, the wrench 300 will be held in place to ensure that the adjustment screw 440 remains in its proper location. This procedure is repeated for all sets of screws. By having the wrench 300 remain engaged with the adjustment screw 400, the wrench 300 will ensure that the adjustment screw 440 will not move during the locking process and, hence, make certain the height of the cup 410 is maintained.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed:

1. A tool, comprising:
a first wrench comprising a handle, a shank portion and an opening extending through the shank portion; and
a second wrench having a handle and a shank portion, the shank of the second wrench extending through the opening of the first wrench such that a tip of the shank portion of the second wrench extends beyond the shank portion of the first wrench.

2. The tool of claim 1, wherein the first wrench and the second wrench are independently rotatable.

3. The tool of claim 2, wherein the opening of the first wrench is larger than a cross section of the shank portion of the second wrench.

4. The tool of claim 1, wherein the handle and the shank portion of the second wrench are provided in a “T” shape.

5. The tool of claim 4, wherein the handle and the shank portion of the first wrench are provided in a “L” shape.

6. The tool of claim 1, wherein the shank portion of the first wrench has a cross-sectional configuration structured to engage a first screw and the shank portion of the second wrench has a cross-sectional configuration structured to engage a second screw.

7. The tool of claim 6, wherein the cross-sectional configuration of the shank portion of both the first wrench and the second wrench comprises a hexagonal shape.

8. The tool of claim 1, further comprising a stop mechanism on the shank portion of the first wrench which is positionable to rest on the handle of the second wrench when the shank portion of the first wrench is inserted into the opening.

9. A tool comprising:
a “L” shaped tool comprising a hollow shank with an exterior cross-sectional configuration structured to engage with a drive portion of a first fastener; and
a “T” shaped tool comprising a shank insertable through the hollow shank and having an exterior cross-sectional configuration structured to engage with a drive portion of a second fastener.

10. The tool of claim 9, wherein the hollow shank and the shank are axially aligned.

11. The tool of claim 9, wherein the “L” shaped tool and the “T” shaped tool are independently rotatable.

12. The tool of claim 9, wherein an interior cross-section of the hollow shank is larger than the exterior cross-sectional configuration of the “T” shaped tool.

13. The tool of claim 9, wherein the exterior cross-sectional configuration of the shank portion of the “T” shaped tool comprises a hexagonal shape.

14. The tool of claim 9, further comprising a stop mechanism on the shank of the “T” shaped tool which is positionable to rest on the handle of the “L” shaped tool when the shank of the “T” shaped tool is inserted into the hollow shank portion.

15. A tool comprising:
a first wrench comprising a handle with an opening and a hollow shank, the opening being aligned with the hollow shank; and
a second wrench comprising a shank insertable through the opening and the hollow shank, such that the hollow shank and the shank are axially alignable and independently rotatable.

16. The tool of claim 15, wherein an interior cross-section of the hollow shank is larger than an exterior cross-sectional configuration of the shank.

17. The tool of claim 16, further comprising a stop mechanism on the shank of the second wrench which is positionable to rest on the handle of the first wrench.

18. The tool of claim 15, wherein the first wrench includes a ratchet mechanism structured to assist in the rotation of the shaft of the first wrench.

19. The tool of claim 15, wherein an exterior cross-sectional configuration of the hollow shank and the shank comprise a hexagonal shape.

20. The tool of claim 15, wherein the first wrench is “L” shaped and the second wrench is “T” shaped.
